(19) United States
(12) Patent Application Publication
(10) Pub. No.: US 2023/0182048 A1
(43) Pub. Date: Jun. 15, 2023

(54) FLUID CONNECTION ELEMENT

(71) Applicant: MAHLE International GmbH, Stuttgart (DE)

(72) Inventors: Stefan Jauss, Donzdorf (DE); Simone Mahr, Weinstadt (DE); Kai-Torsten Schmiedl, Altdorf (DE)

(21) Appl. No.: 18/078,082

(22) Filed: Dec. 8, 2022

(30) Foreign Application Priority Data
Dec. 9, 2021 (DE) 102021006068.7

(51) Int. Cl. B01D 35/00; B01D 35/30; F01M 11/03

(52) U.S. Cl. CPC B01D 35/005; B01D 35/30; F01M 11/03; F01M 2011/031

(57) ABSTRACT

A fluid connection element for a housing element is disclosed. The fluid connection element includes an inlet opening for introducing a fluid into the fluid connection element and an outlet opening for discharging the fluid from the fluid connection element. The outlet opening engages the housing element when the fluid connection element is coupled to the housing element in an installed state. The inlet opening and the outlet opening are coupled via a channel. A valve assembly is arranged in the channel such that the valve assembly is opened or closed as a function of an impulse. The valve assembly in the installed state is arranged at least partially within the housing element.

### CROSS-REFERENCE TO RELATED APPLICATION

This application claims priority to German Application No. DE 10 2021 006 068.7 filed on Dec. 9, 2021, the contents of which are hereby incorporated by reference in its entirety.

### TECHNICAL FIELD

The present invention relates to a fluid connection element for a housing element, in particular for a filter housing in a particularly preferred application for an oil filter housing or a coolant system of a battery system or a fuel cell.

### BACKGROUND

DE 10 2014 216 507 A1 describes a filter device with an inlet/outlet oriented in the direction of a cooling device, in each of which a closure device with a closure element is provided. The disadvantage of this type of valve seat module, which provides the inlet and outlet, is that the valve seat module is attached and fastened to the filter device, requiring considerable installation space.

The present invention is therefore concerned with the problem of providing an improved or at least an alternative embodiment for a fluid connection element of the type described, in particular providing a fluid connection element with a valve assembly integrated therein, which has a reduced installation space in the installed position.

According to the invention, this problem is solved by the subject matter of independent claim(s). Advantageous embodiments are the subject of the dependent claims.

### SUMMARY

The present invention is based on providing a general fluid connection element for a housing element, in particular for a filter housing in a particularly preferred application for an oil filter housing or a coolant system of a battery system or a fuel cell, which has a valve assembly which, in the installed state, is arranged at least partially within the housing element, in particular within a filter housing. The fluid connection element according to the invention has a first fluid connection housing element and a second fluid connection housing element. The first fluid connection housing element includes an inlet opening for introducing a fluid into the fluid connection element. In a preferred embodiment, the area around the inlet opening is in the form of a connecting piece with at least one retaining device to be connected and coupled to standardized connectors. The holding device is designed in such a way that it can interact with the connectors commonly used on the market. This makes it possible to retrofit the fluid connection module in existing systems in order to arrange a valve assembly on a housing element with optimized installation space.

The second fluid connection housing element includes an outlet opening. The inlet opening can be arranged at an angle of approximately 0° as well as at an angle of 0.1-90°, in particular at an angle of 30-60°, in a particularly preferred position at an angle of 45°, to the outlet opening. Due to the different designs in different angular arrangements of the inlet opening to the outlet opening, it is possible to easily design the installation space and the piping around the fluid connection element according to the given installation space requirements and customer wishes, since only the first fluid connection housing element has to be adapted. The second fluid connection housing element further comprises a valve assembly arranged at least partially within the second fluid connection housing element.

Both fluid connection housing elements are connected to each other via a coupling area, in particular detachably connected to each other. The two-part design makes it possible for different embodiments of the first and second fluid connection housing elements to be combined; in particular, if the fluid connection housing element is angled, it is possible to install the valve assembly in the second fluid connection housing element in a simple manner via the coupling area.

The housing element, in particular the filter housing element, includes a coupling area configured to interact with a coupling area of the second fluid connection housing element of the fluid connection element. The coupling of the two fluid connection housing elements can be designed to be detachable as well as non-detachable. In a preferred embodiment, the first fluid connection housing element has at least three snap contours, in particular at least three snap hooks, which engage in a circumferential snap contour of the second fluid connection housing element. Alternatively, the coupling of the first and second fluid connection housing elements may be implemented by means of a thread, bayonet fitting, welding, or bonding. The second fluid connector housing element has the valve assembly at least partially within the fluid connection housing element.

The valve assembly has a valve body, a valve spring and a seal. The valve body, which in a preferred embodiment is made of a plastic, in particular a polyamide, has at least two struts, in a preferred embodiment three struts. The struts connect a circumferential collar to a valve head. The valve head has a circumferential groove to accommodate a seal therein. The valve spring of the valve assembly is supported on a contact surface of the second fluid connection housing element as well as on the circumferential collar of the valve body. This preloads the valve assembly in the second fluid connection housing element. When the valve assembly is closed, the seal of the valve head rests against a seal seat of the second fluid connection housing element, which thus also serves as a valve seat. The seal thereby holds the spring-loaded valve assembly in the second fluid connection housing element. Due to the design of the valve assembly and the interaction of the valve assembly with the second fluid connection housing element, a backflow check valve system requiring fewer elements is provided.

The valve assembly is actuated in response to an impulse. For the purposes of the present invention, an impulse is understood to be a force which engages and comes into contact with the valve body via a pin or extension of a connected pipe section which is connected to the fluid connection element according to the invention, or from a force which is exerted on the valve body via the incoming fluid flow. In each case, the force must be greater than the valve spring force, which preloads the valve body against the valve seat and thus closes it. If no impulse is applied, i.e. no force is applied that is greater than the spring force of the valve, the valve closes or the valve does not open.

In the installed state, the second fluid connection housing element of the fluid connection element is arranged at least partially within the housing element in such a way that the valve assembly is arranged at least partially within the housing element, whereby an installation space-optimized arrangement of the valve assembly for a fluid connection element of a housing element, in particular a filter housing element, is possible for the first time.

In a preferred embodiment, the second fluid connection housing element further comprises a separate seal, which in a particularly preferred embodiment is configured as a circumferential ring or circumferential band.

Further important features and advantages of the invention are apparent from the subclaims, from the drawings, and from the accompanying figure description based on the drawings.

It is understood that the above features and those to be explained below can be used not only in the combination indicated in each case, but also in other combinations or on their own, without departing from the scope of the present invention.

Preferred embodiments of the invention are shown in the drawings by way of example and will be explained in more detail in the following description, wherein identical reference signs refer to identical or similar or functionally identical elements.

### BRIEF DESCRIPTION OF THE DRAWINGS

It shows, each schematically

FIG. 1 a schematic view of a fluid connection element according to the invention

FIG. 2 a cutaway detail view of the fluid connection element according to the invention

### DETAILED DESCRIPTION

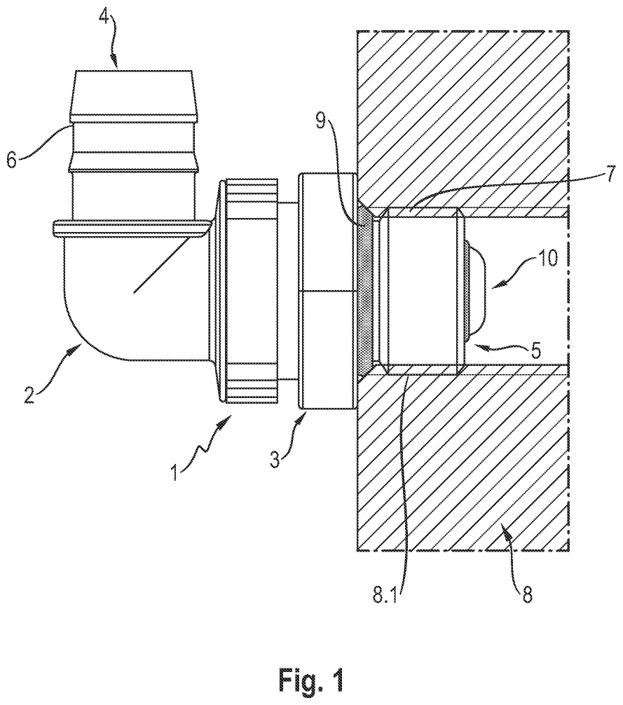

According to FIG. 1, the fluid connection element 1 according to the invention has a first fluid connection housing element 2 and a second fluid connection housing element 3. The first fluid connection housing element 2 has an inlet opening 4 for introducing a fluid into the fluid connection element 1. In a preferred embodiment, the area around the inlet opening 4 is in the form of a connecting piece 6 to be connected and coupled to standardized connectors.

The second fluid connection housing element 3 has an outlet opening 5. The inlet opening 4 is arranged at an angle of 90° to the outlet opening, but can also be arranged in alternative angular arrangements. Due to the different designs in different angular arrangements of the inlet opening 4 to the outlet opening 5, it is possible in a simple way to design the installation space and the piping around the fluid connection component 1 according to the given installation space requirements and customer wishes, since only the first fluid connection housing component 2 has to be adapted. The second fluid connection housing element 3 further comprises a valve assembly 10 arranged at least partially within the second fluid connection housing element.

Both fluid connection housing elements are connected to each other via a coupling area 15, in particular detachably connected to each other. The two-part design makes it possible for different embodiments of the first and second fluid connection housing elements 2.3 to be combined; in particular, with the angled design of the first fluid connection housing element 2 shown, it is possible to install the valve assembly 10 in the second fluid connection housing element 3 in a simple manner via the coupling area.

FIG. 1 also shows schematically a housing element 8, in particular a filter housing element in a particularly preferred embodiment of a filter housing element of an oil filter system. The housing element 8 has a coupling area 8.1, which is configured to interact with a coupling portion 7 of the second fluid connection housing element 3 of the fluid connection element 1. In a preferred embodiment, the coupling area 7.8.1 is designed as a threaded connection. In an alternative embodiment, the coupling area can also be designed as a bayonet connection or by means of a snap connection. In the installed state, the second fluid connection housing element 3 of the fluid connection element 1 is arranged at least partially within the housing element 8 in such a way that the valve assembly 10 is arranged at least partially within the housing element 8, whereby an installation space-optimized arrangement of the valve assembly 10 for a fluid connection element 1 of a housing element 8, in particular a filter housing element, is possible for the first time.

In a preferred embodiment, the second fluid connection housing element 3 further comprises a separate seal 9, which in a particularly preferred embodiment is configured as a circumferential ring.

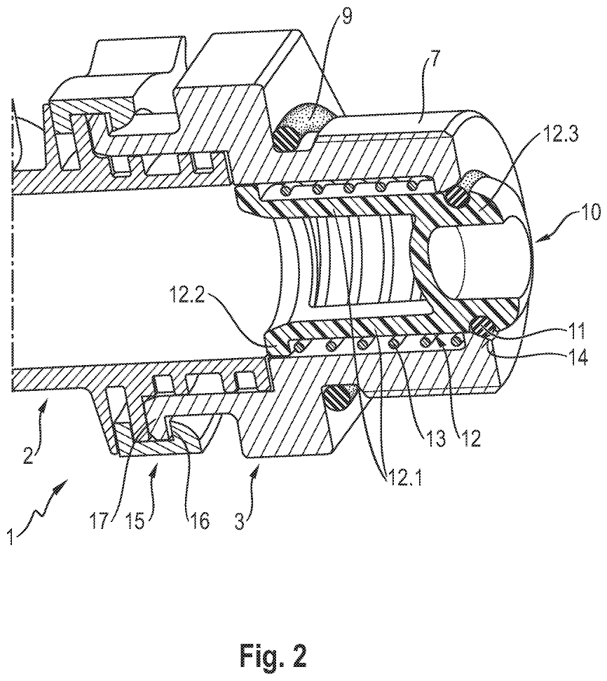

FIG. 2 shows a cutaway detail view of the fluid connection element 1. The first fluid connection housing element 2 is connected to the second fluid connection housing element 3 by means of a coupling area 15. The coupling of the two fluid connection housing elements 2.3 can be designed to be detachable as well as non-detachable. In a preferred embodiment, the first fluid connection housing element 2 has at least three snap contours, in particular at least three snap hooks, which engage in a circumferential snap contour 17 of the second fluid connection housing element 3. Alternatively, the coupling of the first and second fluid connection housing elements may be implemented by means of a thread, bayonet fitting, welding, or bonding.

The second fluid connector housing element 3 has the valve assembly 10 within the fluid connection housing element 3.

The valve assembly 10 has a valve body 12, a valve spring 13 and a seal 11. The valve body 12, which in a preferred embodiment is made of a plastic, in particular a polyamide, has at least two struts 12.1, in a preferred embodiment three struts 12.1. The struts 12.1 connect a circumferential collar 12.2 to a valve head 12.3. The valve head 12.3 has a circumferential groove to accommodate a seal 11 therein.

The valve spring 13 of the valve assembly 10 is supported on a contact surface of the second fluid connection housing element 3 as well as on the circumferential collar 12.2 of the valve body. This preloads the valve assembly 10 in the second fluid connection housing element 3. When the valve assembly 10 is closed, the seal 11 of the valve head 12.3 rests against a seal seat 14 of the second fluid connection housing element 3, which thus also serves as a valve seat. The seal 11 thereby holds the spring-loaded valve assembly 10 in the second fluid connection housing element 3. Due to the design of the valve assembly 10 and the interaction of the valve assembly 10 with the second fluid connection housing element 3, a backflow check valve system requiring fewer elements is provided.

The valve assembly 10 is actuated by means of an impulse, in particular an impulse generated by the force of an incoming fluid. In each case, the force must be greater than the valve spring force, which preloads the valve body against the valve seat and thus closes it. If no impulse is applied, i.e. no force is applied that is greater than the spring force of the valve, the valve closes or the valve does not open.

With the fluid connection element 1 according to the invention, it is possible for the first time to provide a fluid connection element 1 with an integrated valve assembly 10 for a housing element 8, in particular a filter housing element, which is optimized in terms of installation space.

1. A fluid connection element for a housing element, comprising:
an inlet opening for introducing a fluid into the fluid connection element,
an outlet opening for discharging the fluid from the fluid connection element, the outlet opening engaging in the housing element when the fluid connection element is in an installed state and coupled to the housing element,
the inlet opening and the outlet opening connected via a channel,
a valve assembly arranged in the channel such that the valve assembly is opened or closed as a function of an impulse, and
wherein the valve assembly in the installed state is arranged at least partially within the housing element.

2. The fluid connection element according to claim 1, further comprising a plug connection arranged in an area of the inlet opening on an outer circumference of the fluid connection element.

3. The fluid connection element according to claim 1, wherein a coupling area is arranged in an area of the outlet opening on an outer circumference of the fluid connection element to couple the fluid connection element to the housing element.

4. The fluid connection element according to claim 1, further comprising a first fluid connection housing element and a second fluid connection housing element that are connected via a coupling device.

5. The fluid connection element according to claim 4, wherein the coupling device is a snap connection, a bayonet connection or a screw connection.

6. The fluid connection component according to claim 1, wherein the valve assembly comprises a valve body, a spring and a seal, wherein the seal is arranged such that the valve body is held in the fluid connection element when not activated.

7. The fluid connection element according to claim 1, wherein the inlet opening is arranged at an angular range of 0-90° with respect to the outlet opening.

8. A filter system, comprising: a fluid connection element according to and a housing element, the fluid connection element including:
an inlet opening for introducing a fluid into the fluid connection element;
an outlet opening for discharging the fluid from the fluid connection element the outlet opening engaging in the housing element when the fluid connection element is in an installed state and coupled to the housing element;
the inlet opening and the outlet opening connected via a channel;
a valve assembly arranged in the channel such that the valve assembly is opened or closed as a function of an impulse; and
wherein the valve assembly in the installed state is arranged at least partially within the housing element.

9. The filter system according to claim 8, wherein the filter system is an oil filter system.

10. The filter system according to claim 8, further comprising a plug connection arranged in an area of the inlet opening on an outer circumference of the fluid connection element.

11. The filter system according to claim 8, further comprising a coupling area arranged in an area of the outlet opening on an outer circumference of the fluid connection element to couple the fluid connection element to the housing element in the installed state.

12. The filter system according to claim 11, wherein the coupling area comprises a thread or a bayonet closure.

13. The filter system according to claim 8, wherein the fluid connection element includes a first fluid connection housing element and a second fluid connection housing element that are connected via a coupling device.

14. The filter system according to claim 13, wherein the coupling device includes a snap connection, a bayonet connection, or a screw connection.

15. The filter system according to claim 8, wherein the valve assembly comprises a valve body, a spring, and a seal.

16. The filter system according to claim 15, wherein the seal is arranged such that the valve body is held in the fluid connection element when the valve assembly is not activated.

17. The filter system according to claim 8, wherein the inlet opening is arranged at an angular range of 0° to 90° with respect to the outlet opening.

18. The filter system according to claim 17, wherein the angular range of the inlet opening relative to the outlet opening is 45° to 90°.

19. The fluid connection element according to claim 1, wherein the housing element is a filter housing element.

20. The fluid connection element according to claim 1, wherein the inlet opening is arranged at an angular range of 45° to 90° with respect to the outlet opening.
